(19) United States
(12) Patent Application Publication
(10) Pub. No.: US 2022/0036186 A1
(43) Pub. Date: Feb. 3, 2022

(54) ACCELERATED DEEP REINFORCEMENT LEARNING OF AGENT CONTROL POLICIES

(71) Applicant: Waymo LLC, Mountain View, CA (US)

(72) Inventors: Khaled Refaat, Mountain View, CA (US); Kai Ding, Mountain View, CA (US)

(21) Appl. No.: 17/390,800

(22) Filed: Jul. 30, 2021

Related U.S. Application Data
(60) Provisional application No. 63/059,048, filed on Jul. 30, 2020.

(51) Int. Cl. G06N 3/08; G06F 11/00; G05D 1/00

(52) U.S. Cl. CPC G06N 3/08; G06F 11/008; B60W 60/001; G05D 2201/0213; G05D 1/0088

(57) ABSTRACT

Methods, computer systems, and apparatus, including computer programs encoded on computer storage media, for training a mixture of a plurality of actor-critic policies that is used to control an agent interacting with an environment to perform a task. Each actor-critic policy includes an actor policy and a critic policy. The training includes, for each of one or more transitions, determining a target Q value for the transition from (i) the reward in the transition, and (ii) an imagined return estimate generated by performing one or more iterations of a prediction process to generate one or more predicted future transitions.

### CROSS-REFERENCE TO RELATED APPLICATION

This application claims priority to U.S. Provisional Patent Application No. 63/059,048, filed on Jul. 30, 2020, the disclosure of which is hereby incorporated by reference in its entirety.

### BACKGROUND

This specification relates to controlling agents using neural networks.

Neural networks are machine learning models that employ one or more layers of nonlinear units to predict an output for a received input. Some neural networks include one or more hidden layers in addition to an output layer. The output of each hidden layer is used as input to or more other layers in the network, i.e., one or more other hidden layers, the output layer, or both. Each layer of the network generates an output from a received input in accordance with the current values of a respective set of parameters.

### SUMMARY

This specification describes a system implemented as computer programs on one or more computers in one or more locations that learns a policy that is used to control an agent, i.e., to select actions to be performed by the agent while the agent is interacting with an environment, in order to cause the agent to perform a particular task. In particular, the system accelerates deep reinforcement learning of the control policy. “Deep reinforcement learning” refers to the use of deep neural networks that are trained through reinforcement learning to implement the control policy for an agent.

The policy for controlling the agent is a mixture of actor-critic policies. Each actor-critic policy includes an actor policy that is configured to receive an input that includes an observation characterizing a state of the environment and to generate a network output that identifies an action from a set of actions that can be performed by the agent. For example, the network output can be a continuous action vector that defines a multi-dimensional action.

Each actor-critic policy also includes a critic policy that is configured to receive the observation and an action from the set of actions and to generate a Q value for the observation that is an estimate of a return that would be received if the agent performed the identified action in response to the observation. The return is a time-discounted sum of future rewards that would be received starting from the performance of the identified action. The reward, in turn, is a numeric value that is received each time an action is performed, e.g., from the environment, that reflects a progress of the agent in performing the task as a result of performing the action.

Each of these actor and critic policies are implemented as respective deep neural networks each having respective parameters. In some cases, these neural networks share parameters, i.e., some components are common to all of the policies. As a particular example, all of the neural networks can share an encoder neural network that encodes a received observation into an encoded representation that is then processed by separate sub-networks for each actor and critic.

To accelerate the training of these deep neural networks using reinforcement learning, for some or all of the transitions on which the actor-critic policy is trained, the system augments the target Q value for the transition that is used for the training by performing one or more iterations of a prediction process. Performing the prediction process involves generating predicted future transitions using a set of prediction models. Thus, the training of the mixture of actor-critic policies is accelerated because parameter updates leverage not only actual transitions generated as a result of the agent interacting with the environment but also predicted transitions that are predicted by the set of prediction models.

The subject matter described in this specification can be implemented in particular embodiments so as to realize one or more of the following advantages.

A mixture of actor-critic experts (MACE) has been shown to improve the learning of control policies, e.g., as compared to other model-free reinforcement learning algorithms, without hand-crafting sparse representations, as it promotes specialization and makes learning easier for challenging reinforcement learning problems. However, the sample complexity remains large. In other words, learning an effective policy requires a very large number of interactions with a computationally intensive simulator, e.g., when training a policy in simulation for later use in a real-world setting, or a very large number of real-world interactions, which can be difficult to obtain, can be unsafe, or can result in undesirable mechanical wear and tear on the agent.

The described techniques accelerate model-free deep reinforcement learning of the control policy by learning to imagine future experiences that are utilized to speed up the training of the MACE. In particular, the system learns prediction models, e.g., represented as deep convolutional networks to imagine future experiences without relying on the simulator or on real-world interactions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example reinforcement learning system.

FIG. 2 shows an example network architecture of an observation prediction neural network.

FIG. 3 is a flow diagram illustrating an example process for reinforcement learning.

FIG. 4 is a flow diagram illustrating an example process for generating an imagined return estimate for a reinforcement learning system.

Like reference numbers and designations in the various drawings indicate like elements.

### DETAILED DESCRIPTION

This specification describes methods, computer systems, and apparatus, including computer programs encoded on computer storage media, for learning a policy that is used to control an agent, i.e., to select actions to be performed by the agent while the agent is interacting with an environment, in order to cause the agent to perform a particular task.

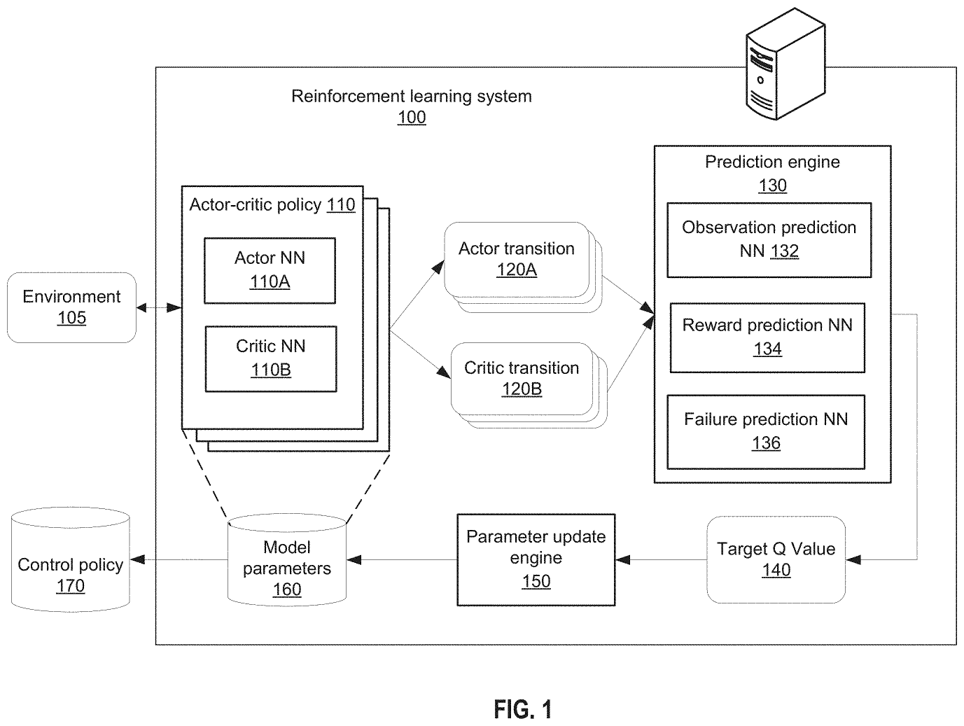

FIG. 1 shows an example of a reinforcement learning system 100. The system 100 is an example of a system implemented as computer programs on one or more computers in one or more locations, in which the systems, components, and techniques described below can be implemented.

The system 100 learns a control policy 170 for controlling an agent, i.e., for selecting actions to be performed by the agent while the agent is interacting with an environment 105, in order to cause the agent to perform a particular task.

As a particular example, the agent can be an autonomous vehicle, the actions can be future trajectories of the autonomous vehicle or high-level driving intents of the autonomous vehicle, e.g., high-level driving maneuvers like making a lane change or making a turn, that are translated into future trajectories by a trajectory planning system for the autonomous vehicle, and the task can be a task that relates to autonomous navigation. The task can be, for example, to navigate to a particular location in the environment while satisfying certain constraints, e.g., not getting too close to other road users, not colliding with other road users, not getting stuck in a particular location, following road rules, reaching the destination in time, and so on.

More generally, however, the agent can be any controllable agent, e.g., a robot, an industrial facility, e.g., a data center or a power grid, or a software agent. For example, when the agent is a robot, the task can include causing the robot to navigate to different locations in the environment, causing the robot to locate different objects, causing the robot to pick up different objects or to move different objects to one or more specified locations, and so on.

In this specification, the “state of the environment” indicates one or more characterizations of the environment that the agent is interacting with. In some implementations, the state of the environment further indicates one or more characterizations of the agent. In an example, the agent is a robot interacting with objects in the environment. The state of the environment can indicate the positions of the objects as well as the positions and motion parameters of components of the robot.

In this specification, a task can be considered to be “failed” when the state of the environment is in a predefined “failure” state or when the task is not accomplished after a predefined duration of time has elapsed. In an example, the task is to control an autonomous vehicle to navigate to a particular location in the environment. The task can be defined as being failed when the autonomous vehicle collides with another road user, gets stuck in a particular location, violates road rules, or does not reach the destination in time.

In general, the goal of the system 100 is to learn an optimized control policy 170 that maximizes an expected return. The return can be a time-discounted sum of future rewards that would be received starting from the performance of the identified action. The reward, in turn, is a numeric value that is received each time an action is performed, e.g., from the environment.

As a particular example, the reward can be a sparse binary reward that is zero unless the task is successfully completed and one if the task is successfully completed as a result of the action performed.

As another particular example, the reward can be a dense reward that measures a progress of the agent towards completing the task as of individual observations received during an episode of attempting to perform the task. That is, individual observations can be associated with non-zero reward values that indicate the progress of the agent towards completing the task when the environment is in the state characterized by the observation.

In an example, the system 100 is configured to learn a control policy it(s) that maps a state of the environment s∈S to an action a∈A to be executed by the agent. At each time step t∈[0, Γ], the agent executes an action aₜ=π(sₜ) in the environment. In response, the environment transitions into a new state sₜ₊₁ and the system 100 receives a reward r(sₜ, aₜ, sₜ₊₁). The goal is to learn a policy that maximizes the expected sum of discounted future rewards (i.e., the expected discounted return) from a random initial state S₀.

The expected discounted return V(s₀) can be expressed as

V(s₀)=r₀+γr₁+ . . . +γ^{T}r_{T} (1)

where rᵢ=r(sᵢ, aᵢ, sᵢ₊₁), and the discount factor γ<1.

In particular, the policy for controlling the agent is a mixture of multiple actor-critic policies 110. Each actor-critic policy includes an actor policy 110A and a critic policy 110B.

The actor policy 110A is configured to receive an input that includes an observation characterizing a state of the environment and to generate a network output that identifies an action from a set of actions that can be performed by the agent. For example, the network output can be a continuous action vector that defines a multi-dimensional action.

The critic policy 110B is configured to receive the observation and an action from the set of actions and to generate a Q value for the observation that is an estimate of a return that would be received if the agent performed the identified action in response to the observation. The return is a time-discounted sum of future rewards that would be received starting from the performance of the identified action. The reward, in turn, is a numeric value that is received each time an action is performed, e.g., from the environment, that reflects a progress of the agent in performing the task as a result of performing the action.

Each of these actor and critic policies are implemented as respective neural networks. That is, each of the actor policies 110A is an actor neural network having a set of neural network parameters. Each of the critic neural networks 110B is a critic neural network having another set of neural network parameters.

The actor neural networks 110A and the critic neural networks 110B can have any appropriate architectures. As a particular example, when the observations include high-dimensional sensor data, e.g., images or laser data, the actor-critic neural network 110 can be a convolutional neural network. As another example, when the observations include only relatively lower-dimensional inputs, e.g., sensor readings that characterize the current state of a robot, the actor-critic network 110 can be a multi-layer perceptron (MLP) network. As yet another example, when the observations include both high-dimensional sensor data and lower-dimensional inputs, the actor-critic network 110 can include a convolutional encoder that encodes the high-dimensional data, a fully-connected encoder that encodes the lower-dimensional data, and a policy subnetwork that operates on a combination, e.g., a concatenation, of the encoded data to generate the policy output.

In some cases, the actor neural networks and the critic neural networks share parameters, i.e., some parameters are common to different networks. For example, the actor policy 110A and the critic policy 110B within each actor-critic policy 110 can share parameters. Further, the actor policies 110A and the critic policies 110B across different actor-critic policies can share parameters. As a particular example, all of the actor-critic pairs in the mixture can share an encoder neural network that encodes a received observation into an encoded representation that is then processed by separate sub-networks for each actor and critic. Each neural network in the mixture further has its own set of layers, e.g., one or more fully connected layers and/or recurrent layers.

The system performs training of actor-critic policies 110 to learn the model parameters 160 of the policies using reinforcement learning. After the policies are learned, the system 100 can use the trained actor-critic pairs to control the agent. As a particular example, when an observation is received after learning, the system 100 can process the observation using each of the actors to generate a respective proposed action for each actor-critic pair. The system 100 can then, for each pair, process the proposed action for the pair using the critic in the pair to generate a respective Q value for the proposed for each pair. The system 100 can then select the proposed action with the highest Q value as the action to be performed by the agent in response to the observation.

The system can perform training of the actor-critic policies 110 based on transitions characterizing the interactions between the agent and the environment 105. In particular, to accelerate the training of the policies, for some or all of the transitions on which the actor-critic policy 110 is trained, the system 100 augments the target Q value for the transition that is used for the training by performing one or more iterations of a prediction process. Performing the prediction process involves generating predicted future transitions using a set of prediction models. Thus, the training of the mixture of actor-critic policies is accelerated because parameter updates leverage not only actual transitions generated as a result of the agent interacting with the environment but also predicted transitions that are predicted by the set of prediction models.

The system 100 can train the critic neural networks 110B on one or more of critic transitions 120B generated as a result of interactions of the agent with the environment 105 based on actions selected by one or more of the actor-critic policies 110. Each critic transition includes: a first training observation, a reward received as a result of the agent performing a first action in response to the first training observation, a second training observation characterizing a state that the environment transitioned into as a result of the agent performing the first action, and identification data that identifies one of the actor-critic policies that was used to select the first action.

In an example, the system stores each transition as a tuple (sᵢ, aᵢ, rₜᵢ, sᵢ₊₁, μᵢ), where μᵢ indicates the index of the actor-critic policy 110 used to select the action aᵢ. The system can store the tuple in a first replay buffer used for learning the critic policies 110B. To update the critic parameters, the system can sample a mini batch of tuples for further processing.

For each critic transition 120B that the system 100 samples, the system 100 uses a prediction engine 130 to perform a prediction process to generate an imagined return estimate. Concretely, the prediction engine 130 can perform one or more iterations of a prediction process starting from the second training observation sᵢ₊₁. In each iteration, the prediction engine 130 generates a predicted future transition. After the iterations, the prediction engine 130 determines the imagined return estimate using the predicted future rewards generated in the iterations.

More specifically, the prediction engine 130 first obtains an input observation for the prediction process. In particular, for the first iteration of the prediction process, the input observation characterizes a state of the environment that the environment transitioned into as a result of the agent performing an action selected by one of the actor-critic policies. That is, in the first iteration of the prediction process for updating a critic policy, the input observation can be the second training observation from one of the critic transitions used for updating the critic parameters. For any iteration of the prediction process that is after the first iteration, the input observation is a predicted observation generated at the preceding iteration of the prediction process.

In an example, the prediction engine 130 uses sᵢ₊₁ from a tuple (sᵢ, aᵢ, rᵢ, sᵢ₊₁, μᵢ) stored in the first replay buffer as the input observation of the first iteration of the prediction process for updating the critic parameters.

The prediction engine 130 also selects an action. For example, the system can use the actor policy of one of the actor-critic policies to select the action. In a particular example, the prediction engine can select an actor-critic policy from the mixture of actor-critic policies that produces the best Q value when applying the actor-critic policy to the state characterized by the input observation, and use the actor policy of the selected actor-critic policy to select the action.

The prediction engine 130 processes the input observation and the selected action using an observation prediction neural network 132 to generate a predicted observation. The observation prediction neural network 132 is configured to process an input including the input observation and the selected action, and generate an output including a predicted observation that characterizes a state that the environment would transition into if the agent performed the selected action when the environment was in a state characterized by the input observation.

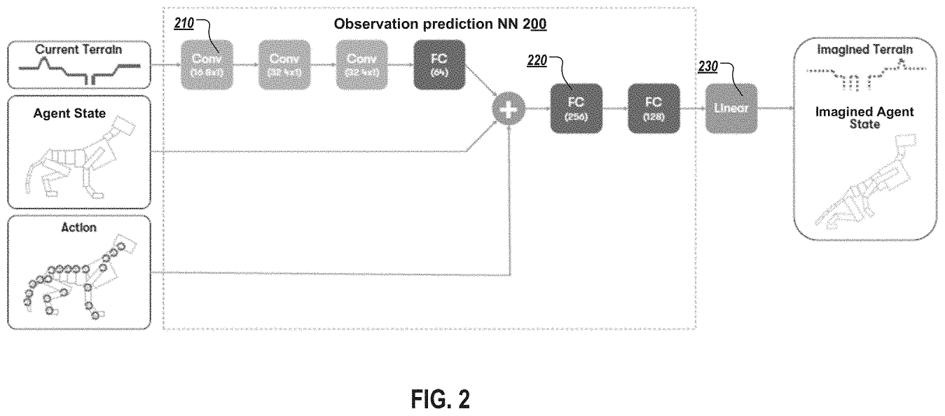

The observation prediction neural network can have any appropriate neural network architecture. In some implementations, the observation prediction neural network includes one or more convolutional layers for processing an image-based input. An example of the neural network architecture of the observation prediction neural network is described in more detail with reference to FIG. 2.

The prediction engine 130 further processes the input observation and the selected action using a reward prediction neural network 134 to generate a predicted reward. The reward prediction neural network 134 is configured to process an input including the input observation and the input action, and generate an output including a predicted reward that is a prediction of a reward that would be received if the agent performed the selected action when the environment was in the state characterized by the input observation.

The reward prediction neural network can have any appropriate neural network architecture. In some implementations, the reward prediction neural network can have a similar neural network architecture as the observation prediction neural network, and include one or more convolutional layers.

The observation prediction neural network and the reward prediction neural network are configured to generate “imagined” future transitions and rewards that will be used to evaluate the target Q values for updating the model parameters of the actor-critic policies. In general, the prediction process using the observation prediction neural network and the reward prediction neural network requires less time, and less computational and/or other resources, comparing to generating actual transitions as a result of the agent interacting with the environment. By leveraging the predicted transitions and transitions that are predicted by the observation prediction neural network and the reward prediction neural network, the training of the policies is accelerated and becomes more efficient. Further, replacing real-world interactions with predicted future transitions also prevents potentially unsafe actions from needing to be performed in the real world and reduces potential hazard and wear and tear on the agent when the agent is a real-world agent

Optionally, the prediction engine 130 further processes the input observation and the selected action using a failure prediction neural network 136 to generate a failure prediction. The failure prediction neural network 136 is configured to process an input including the input observation and the input action, and generate an output that includes a failure prediction of whether the task would be failed if the agent performed the selected action when the environment was in the state characterized by the input observation.

The failure prediction neural network can have any appropriate neural network architecture. In some implementations, the failure prediction neural network can have a similar neural network architecture as the observation prediction neural network, and include one or more convolutional layers.

The prediction engine 130 can use the failure prediction to skip iterations of the prediction process if it is predicted that the task would be failed. The prediction engine 130 can perform iterations of the prediction process until either (i) a predetermined number of iterations of the prediction process are performed or (ii) the failure prediction for a performed iteration indicates that the task would be failed.

For each new iteration (after the first iteration in the prediction process), the prediction engine 130 uses the observation generated at the preceding iteration of the prediction process as the input observation to the observation prediction neural network 132, the reward prediction neural network 134, and the failure prediction neural network.

If the predetermined number of iterations of the prediction process have been performed without reaching a failure prediction, the prediction engine 130 will stop the iteration process, and determine the imagined return estimate from (i) the predicted rewards for each of the predetermined number of iterations of the prediction process and (ii) the maximum of any Q value generated for the predicted observation generated during the last iteration of the predetermined number of iterations by any of the actor-critic policies.

In an example, the system determines the imagined return estimate \hat{V}(sᵢ₊₁) as:

$$\hat{𝒱} ( {s}_{i + 1} ) = {\sum }_{t = 1}^{H - 1} {γ}^{t} {\hat{r}}_{i + t} + {γ}^{H} {max}_{μ} {Q}_{μ} ( {\hat{s}}_{i + H} \vert θ ) \qquad ( 2 )$$

where H is the predetermined number of iterations, \hat{r}ᵢ₊₁ . . . \hat{r}_{i+H-1} and ŝ_{i+H} are generated by applying the prediction process via the selected policy to predict the imaged next states and rewards. [symbol] _{μ}(ŝ_{i+H}|θ) is the [symbol] -value generated by the critic policy for executing the selected action from the actor policy [symbol] _{μ} during the last iteration of the prediction process.

$${max}_{μ} {Q}_{μ} ( {\hat{s}}_{i + H} \vert θ )$$

is the maximum of any Q values generated during the last iteration of the prediction process by processing the observation ŝ_{i+H} using the action selected by any of the actor-critic policies.

If the failure prediction for a performed iteration indicates that the task would be failed, the prediction engine 130 will stop the iteration process and determine the imagined return estimate from the predicted rewards for each of the iterations of the prediction process that were performed and not from the maximum of any Q value generated for the predicted observation generated during the particular iteration by any of the actor-critic policies.

In an example, the prediction engine 130 determines the imagined return estimate as:

\hat{V}(sᵢ₊₁)=Σₜ₌₁^{F-1}γ^{t}\hat{r}ᵢ₊ₜ (3)

where F is the index of the iteration that predicts the task would be failed.

After the iterations of the prediction process having been performed, the system 100 determines a target Q value 140 for the particular critic transition 120B. In particular, the system 100 determines the target Q value for the critic transition 120B based on (i) the reward in the critic transition, and (ii) the imagined return estimate generated by the prediction process.

In an example, the system 100 computes the target Q value yᵢ as:

yᵢ=rᵢ+\hat{V}(sᵢ₊₁) (4)

where \hat{V}(sᵢ₊₁) is the imagined return estimate generated by the prediction process starting at the state sᵢ₊₁.

The system 100 uses a parameter update engine 150 to determine an update to the critic parameters of the critic policy 120B of the actor-critic policy used to select the first action. The parameter update engine 150 can determine the update using (i) the target Q value for the critic transition and (ii) a Q value for the first training observation generated using the actor-critic policy used to select the first action.

In an example, the parameter update engine 150 updates the critic parameters using:

$$θ ← θ + α ( \frac{1}{n} {\sum }_{i} ( {y}_{i} - {Q}_{{μ}_{i}} ( {s}_{i} \vert θ ) ) \frac{\partial {Q}_{{μ}_{i}} ( {s}_{i} \vert θ )}{\partial θ} ) \qquad ( 5 )$$

where [symbol] _{μ}_{ᵢ}(s|θ) is the [symbol] -value predicted by the critic policy for executing the action from the actor policy [symbol] _{μ}_{ᵢ}.

Similar to the processes described above for determining updates to the critic parameters of the critic policies 110B, the system 100 can determine updates to the actor parameters of the actor policies 110A based on one or more actor transitions 120A.

Each actor transition 120A includes: a third training observation, a reward received as a result of the agent performing a third action, a fourth training observation, and identification data identifying an actor-critic policy from the mixture of actor-critic policies.

In an example, similar to the critic transitions 120B, each actor transition 120A is stored as a tuple (sᵢ, aᵢ, rᵢ, sᵢ₊₁, μᵢ). Here, aᵢ is an exploratory action generated by adding an exploration noise to the action a′ᵢ selected by the actor-critic policy in response to sᵢ. μᵢ indicates the index of the actor-critic policy 110 used to select the action a′ᵢ. The tuple can be stored in a second replay buffer used for learning the actor policies 110A. To update the actor parameters, the system samples a mini-batch of tuples for further processing.

For each actor transition 120A, the system uses the prediction engine 130 to perform the prediction process, including one or more iterations, to generate an imagined return estimate. The system 100 determines a target Q value for the actor transition 120A based on (i) the reward in the actor transition, and (ii) the imagined return estimate generated by the prediction process.

The system can determine whether to update the actor parameters of the actor policy 110A of the actor-critic policy 110 used to select the third action based on the target Q value. In particular, the system 100 can determine whether the target Q value is greater than the maximum of any Q value generated for the third observation by any of the actor-critic policies. If the target Q value is greater than the maximum of any Q value generated for the third observation by any of the actor-critic policies, it indicates room for improving the actor policy 110A, and the system 100 can proceed to update the actor parameters of the actor policy 110A.

In an example, the system 100 computes:

$${δ}_{j} = {y}_{j} - {max}_{μ} {Q}_{μ} ( {s}_{j} \vert θ ) \qquad ( 6 )$$

where yⱼ is computed using the exploratory action aⱼ. If δⱼ>0, which indicates a room for improving the actor policy, the system 100 performs an update to the actor parameters.

In particular, if δⱼ>0, the parameter update engine 150 can determine the update to the actor parameters of the actor policy 110A of the actor-critic policy 110 used to select the third action. The parameter update engine 150 can determine the update using an action identified for the third training observation generated using the actor-critic policy 110 used to select the third action.

In an example, the system updates the actor parameters using:

$$θ ← θ + α ( \frac{1}{n} ( {a}_{j} - {𝒜}_{{μ}_{j}} ( {s}_{j} \vert θ ) ) \frac{\partial {𝒜}_{{μ}_{j}} ( {s}_{j} \vert θ )}{\partial θ} ) \qquad ( 7 )$$

The update to the actor parameters does not depend on the target Q value yⱼ, e.g., as shown by Eq. (7). Therefore, in some implementations, the system 100 directly computes the updates to the actor parameters using the action a₁ identified for the third training observation without computing the target Q value or performing the comparison between the target Q value and the maximum of any Q value generated for the third observation.

In some implementations, the system 100 performs training of the observation prediction neural network, 132, the reward prediction neural network 134, and the failure prediction neural network 136 on the one or more actor transitions 120A and/or the one or more critic transitions 120B.

In an example, the system 100 trains the observation prediction neural network 132 to minimize a mean squared error loss function between predicted observations and corresponding observations from transitions.

The system 100 trains the reward prediction neural network 134 to minimize a mean squared error loss function between predicted rewards and corresponding rewards from transitions.

The system 100 trains the failure prediction neural network 136 to minimize a sigmoid cross-entropy loss between failure predictions and whether failure occurred in corresponding observations from transitions, i.e., whether a corresponding observation in a transition actually characterized a failure state. The system 100 can update the neural network parameters (e.g., weight and bias coefficients) of the observation prediction neural network, the reward prediction neural network, and the failure prediction neural network computed on the transitions 120A and/or 120B using any appropriate backpropagation-based machine-learning technique, e.g., using the Adam or AdaGrad algorithms.

FIG. 2 shows an example network architecture of an observation prediction neural network 200. For convenience, the observation prediction neural network 200 will be described as being implemented by a system of one or more computers located in one or more locations. For example, a reinforcement learning system, e.g., the reinforcement learning system 100 of FIG. 1, appropriately programmed in accordance with this specification, can implement the observation prediction neural network 200. The observation prediction neural network 200 can be a particular example of the observation prediction neural network 132 of the system 100.

The system uses the observation prediction neural network 200 for accelerating reinforcement learning of a policy that controls the dynamics of an agent having multiple controllable joints interacting with an environment that has varying terrains, i.e., so that different states of the environment are distinguished at least by a difference in the terrain of the environment. Each state observation of the interaction includes both characterizations of the current terrain and the state of the agent (e.g., the positions and motion parameters of the joints). The task is to control the agent to traverse the terrain while avoiding collisions and falls.

In particular, the observation prediction neural network 200 is configured to process the state of the current terrain, the state of the agent, and a selected action to predict an imagined transition including the imagined next terrain and imagined next state of the agent. The observation prediction neural network 200 can include one or more convolution layers 210 and fully connected layer 220, and a linear regression output layer 230.

In some implementations, neural network architectures that are similar to the architecture of the observation prediction neural network 200 can be used for the reward prediction neural network and the failure prediction neural network of the reinforcement learning system. For example, the observation prediction neural network, the reward prediction neural network, and the failure prediction neural network of the reinforcement learning system can have the same basic architectures including the convolutional and fully-connected layers, with only the output layers and loss functions being different.

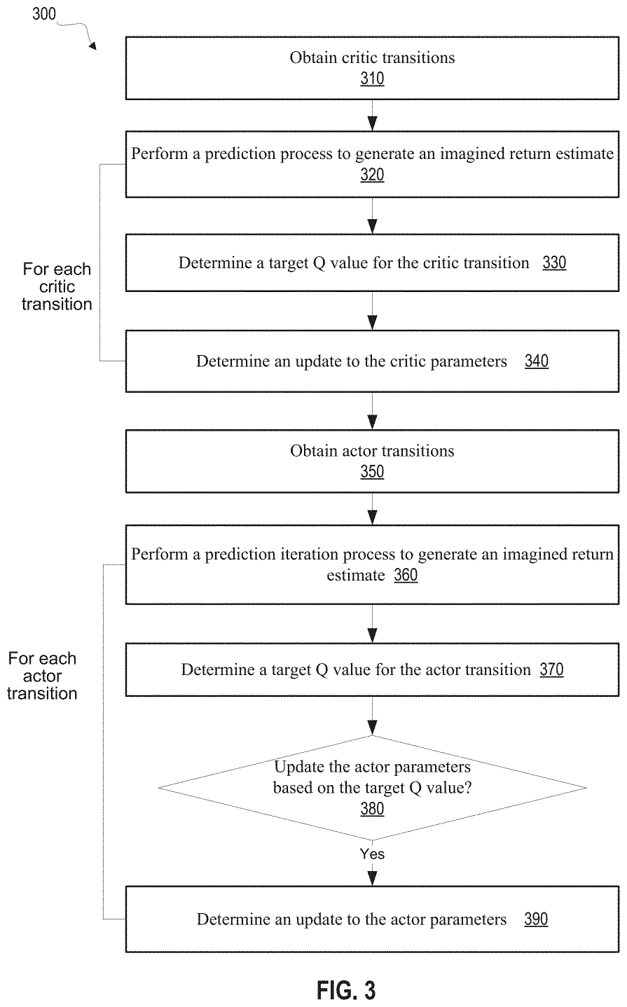

FIG. 3 is a flow diagram illustrating an example process 300 for reinforcement learning of a policy. For convenience, the process 300 will be described as being performed by a system of one or more computers located in one or more locations. For example, a reinforcement learning system, e.g., the reinforcement learning system 100 of FIG. 1, appropriately programmed in accordance with this specification, can perform the process 300 to perform reinforcement learning of the policy.

The control policy learned by process 300 is for controlling an agent, i.e., to select actions to be performed by the agent while the agent is interacting with an environment, in order to cause the agent to perform a particular task. The policy for controlling the agent is a mixture of actor-critic policies. Each actor-critic policy includes an actor policy and a critic policy.

The actor policy is configured to receive an input that includes an observation characterizing a state of the environment and to generate a network output that identifies an action from a set of actions that can be performed by the agent. For example, the network output can be a continuous action vector that defines a multi-dimensional action.

The critic policy is configured to receive the observation and an action from the set of actions and to generate a Q value for the observation that is an estimate of a return that would be received if the agent performed the identified action in response to the observation. The return is a time-discounted sum of future rewards that would be received starting from the performance of the identified action. The reward, in turn, is a numeric value that is received each time an action is performed, e.g., from the environment, that reflects a progress of the agent in performing the task as a result of performing the action.

Each of these actor and critic policies are implemented as respective deep neural networks each having respective parameters. In some cases, these neural networks share parameters, i.e., some parameters are common to different networks. For example, the actor policy and the critic policy within each actor-critic policy can share parameters. Further, the actor policies and the critic policies across different actor-critic policies can share parameters. As a particular example, all of the neural networks in the mixture can share an encoder neural network that encodes a received observation into an encoded representation that is then processed by separate sub-networks for each actor and critic.

The process 300 includes steps 310-340 in which the system updates the model parameters for one or more critic policies. In some implementations, the process further includes steps 350-390 in which the system updates the model parameters for one or more actor policies.

In step 310, the system obtains one or more critic transitions. Each critic transition includes: a first training observation, a reward received as a result of the agent performing a first action, a second training observation, and identification data that identifies one of the actor-critic policies. The first training observation characterizes a state of the environment. The first action is an action identified by the output of an actor policy in response to the state of the environment characterized by the first training observation. The second training observation characterizes a state of the environment that the environment transitioned into as a result of the agent performing the first action. The identification data identifies the actor-critic policy from the mixture of actor-critic policies that was used to select the first action.

Next, the system performs steps 320-340 for each critic transition.

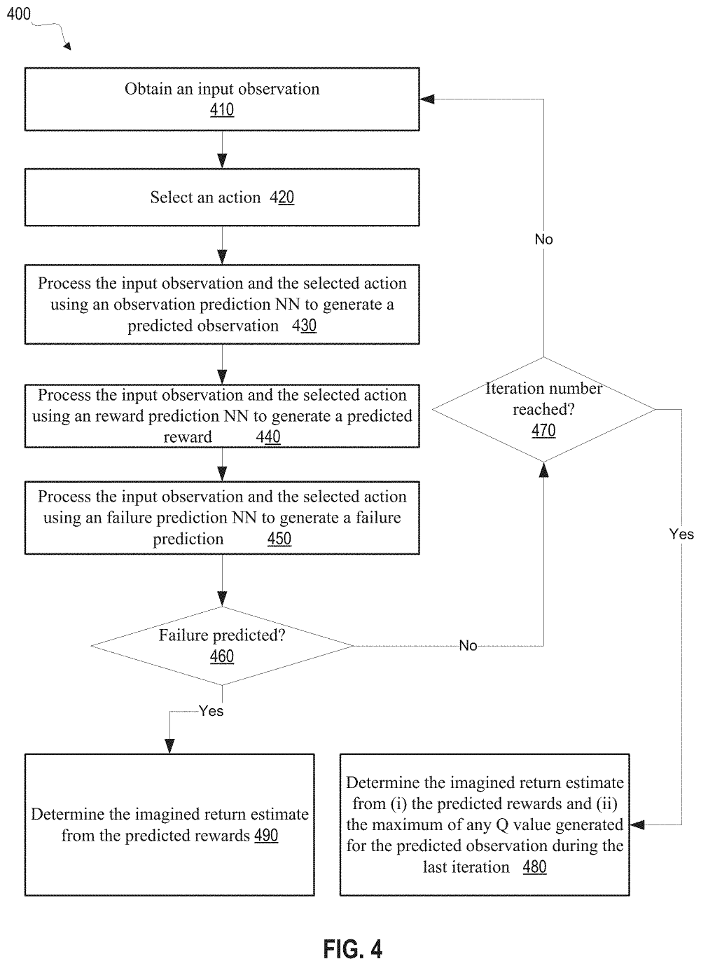

In step 320, the system performs a prediction process to generate an imagined return estimate. An example of the prediction iteration process will be described in detail with reference to FIG. 4. Briefly, the system performs one or more iterations of a prediction process starting from the second training observation. In each iteration, the system generates a predicted future transition. After the iterations, the system determines the imagined return estimate using the predicted future rewards generated in the iterations.

In step 330, the system determines a target Q value for the critic transition. In particular, the system determines the target Q value for the critic transition based on (i) the reward in the critic transition, and (ii) the imagined return estimate generated by the prediction process.

In step 340, the system determines an update to the critic parameters. In particular, the system determines an update to the critic parameters of the critic policy of the actor-critic policy used to select the first action using (i) the target Q value for the critic transition and (ii) a Q value for the first training observation generated using the actor-critic policy used to select the first action.

Similar to the steps 310-340 in which the system determines updates to the critic parameters of the critic policies, the system can also perform steps to determine updates to the actor parameters of the actor policies.

In step 350, the system obtains one or more actor transitions. Each actor transition includes: a third training observation, a reward received as a result of the agent performing a third action, a fourth training observation, and identification data identifying an actor-critic policy from the mixture of actor-critic policies. The third training observation characterizes a state of the environment. The second action can be an exploratory action that was generated by applying noise to an action identified by the output of the action policy of the actor-critic policy used to select the third action. The fourth training observation characterizes a state of the environment that the environment transitioned into as a result of the agent performing the second action. The identification data identifies the actor-critic policy from the mixture of actor-critic policies that was used to select the second action.

Next, the system performs steps 360-380 for each actor transition.

In step 360, the system performs a prediction process to generate an imagined return estimate. Similar to step 320, the system performs one or more iterations of a prediction process starting from the fourth training observation. In each iteration, the system generates a predicted future transition and a predicted reward. After the iterations, the system determines the imagined return estimate using the predicted rewards generated in the iterations.

In step 370, the system determines a target Q value for the actor transition. In particular, the system determines the target Q value for the actor transition based on (i) the reward in the actor transition, and (ii) the imagined return estimate generated by the prediction process.

In step 380, the system determines whether to update the actor parameters of the actor policy of the actor-critic policy used to select the third action based on the target Q value. In particular, the system can determine whether the target Q value is greater than the maximum of any Q value generated for the third observation by any of the actor-critic policies. If the target Q value is greater than the maximum of any Q value generated for the third observation by any of the actor-critic policies, it indicates a room for improving the actor policy, and the system can determine to proceed to step 390 to update the actor parameters of the actor policy.

In step 390, the system determines an update to the actor parameters. In particular, the system determines the update to the actor parameters of the actor policy of the actor-critic policy used to select the third action using an action identified for the third training observation generated using the actor-critic policy used to select the third action.

FIG. 4 is a flow diagram illustrating an example process 400 for generating an imagined return estimate. For convenience, the process 400 will be described as being performed by a system of one or more computers located in one or more locations. For example, a reinforcement learning system, e.g., the reinforcement learning system 100 of FIG. 1, appropriately programmed in accordance with this specification, can perform the process 400 to generate the imagined return estimate.

In step 410, the system obtains an input observation for the prediction process. In particular, for the first iteration of the prediction process, the input observation characterizes a state of the environment that the environment transitioned into as a result of the agent performing an action selected by one of the actor-critic policies. That is, in the first iteration of the prediction process for updating a critic policy, the input observation can be the second training observation from one of the critic transitions used for updating the critic parameters. Similarly, in the first iteration of the prediction process for updating an actor policy, the input observation can be the fourth training observation from one of the actor transitions used for updating the actor parameters. For any iteration of the prediction process that is after the first iteration, the input observation is a predicted observation generated at the preceding iteration of the prediction process.

In step 420, the system selects an action. For example, the system can use the actor policy of one of the actor-critic policies to select the action. In a particular example, the prediction engine can select an actor-critic policy from the mixture of actor-critic policies that produces the best Q value when applying the actor-critic policy to the state characterized by the input observation, and use the actor policy of the selected actor-critic policy to select the action.

In step 430, the system processes the input observation and the selected action using an observation prediction neural network to generate a predicted observation. The observation prediction neural network is configured to process an input including the input observation and the selected action, and generate an output including a predicted observation that characterizes a state that the environment would transition into if the agent performed the selected action when the environment was in a state characterized by the input observation.

The observation prediction neural network can have any appropriate neural network architecture. In some implementations, the observation prediction neural network includes one or more convolutional layers for processing an image-based input.

In step 440, the system processes the input observation and the selected action using a reward prediction neural network to generate a predicted reward. The reward prediction neural network is configured to process an input including the input observation and the input action, and generate an output that includes a predicted reward that is a prediction of a reward that would be received if the agent performed the selected action when the environment was in the state characterized by the input observation.

The reward prediction neural network can have any appropriate neural network architecture. In some implementations, the reward prediction neural network can have a similar neural network architecture as the observation prediction neural network, and include one or more convolutional layers.

Optionally, in step 450, the system further processes the input observation and the selected action using a failure prediction neural network to generate a failure prediction. The failure prediction neural network is configured to process an input including the input observation and the input action, and generate an output that includes a failure prediction of whether the task would be failed if the agent performed the selected action when the environment was in the state characterized by the input observation.

The failure prediction neural network can have any appropriate neural network architecture. In some implementations, the failure prediction neural network can have a similar neural network architecture as the observation prediction neural network, and include one or more convolutional layers.

Optionally, in step 460, the system determines whether the failure prediction indicates that the task would be failed. If it is determined that the task would not be failed, the system performs step 470 to check if a predetermined number of iterations have been performed. If the predetermined number of iterations has not been reached, the system will perform the next iteration starting at step 410.

If the predetermined number of iterations of the prediction process have been performed without reaching a failure prediction, as being determined at the step 470, the system will stop the iteration process and perform step 490 to determine the imagined return estimate from the predicted rewards.

In particular, in step 490, the system determines the imagined return estimate from (i) the predicted rewards for each of the predetermined number of iterations of the prediction process and (ii) the maximum of any Q value generated for the predicted observation generated during the last iteration of the predetermined number of iterations by any of the actor-critic policies.

If the failure prediction for a performed iteration indicates that the task would be failed, as being determined at the step 460, the system will stop the iteration process and perform step 490 to determine the imagined return estimate from the predicted rewards. In particular, in step 490, the system determines the imagined return estimate from the predicted rewards for each of the iterations of the prediction process that were performed and not from the maximum of any Q value generated for the predicted observation generated during the particular iteration by any of the actor-critic policies.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other units suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification, the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of nonvolatile memory, media, and memory devices, including by way of example semiconductor memory devices, e.g., EPROM, EEPROM, and flash memory devices; magnetic disks, e.g., internal hard disks or removable disks; magneto-optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship between client and server arises by virtue of computer programs running on the respective computers and having a client-server relationship with each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated into a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claim is:

1. A method for training a mixture of a plurality of actor-critic policies that is used to control an agent interacting with an environment to perform a task, each actor-critic policy comprising:
an actor policy having a plurality of actor parameters and configured to receive an input comprising an observation characterizing a state of the environment and to generate a network output that identifies an action from a set of actions that can be performed by the agent, and
a critic policy having a plurality of critic parameters and configured to receive the observation and an action from the set of actions and to generate a Q value for the observation that is an estimate of a return that would be received if the agent performed the identified action in response to the observation, and the method comprising:
obtaining one or more critic transitions, each critic transition comprising:
a first training observation,
a reward received as a result of the agent performing a first action in response to the first training observation,
a second training observation characterizing a state of the environment that the environment transitioned into as a result of the agent performing the first action in response to the first training observation, and
data identifying the actor-critic policy from the mixture of actor-critic policies that was used to select the first action;
for each of the one or more critic transitions:
determining a target Q value for the critic transition from (i) the reward in the critic transition, and (ii) an imagined return estimate generated by performing one or more iterations of a prediction process to generate one or more predicted future transitions starting from the second training observation; and
determining an update to the critic parameters of the critic policy of the actor-critic policy used to select the first action using (i) the target Q value for the critic transition and (ii) a Q value for the first training observation generated using the actor-critic policy used to select the first action.

2. The method of claim 1, further comprising:
obtaining one or more actor transitions, each actor transition comprising:
a third training observation,
a reward received as a result of the agent performing a third action in response to the third training observation,
a fourth training observation characterizing a state of the environment that the environment transitioned into as a result of the agent performing the third action in response to the third training observation, and
data identifying the actor-critic policy from the mixture of actor-critic policies that was used to select the third action;
for each of the one or more actor transitions:
determining a target Q value for the actor transition from (i) the reward in the actor transition, and (ii) an imagined return estimate generated by performing one or more iterations of the prediction process to generate one or more predicted future transitions starting from the fourth training observation;
determining whether to update the actor parameters of the actor policy of the actor-critic policy used to select the third action based on the target Q value; and
in response to determining to update the actor parameters of the actor policy of the actor-critic policy used to select the third action, determining an update to the actor parameters of the actor policy of the actor-critic policy used to select the third action using an action identified for the third training observation generated using the actor-critic policy used to select the third action.

3. The method of claim 2, wherein the third action is an exploratory action that was generated by applying noise to an action identified by the output of the action policy of the actor-critic policy used to select the third action.

4. The method of claim 2, wherein determining whether to update the actor parameters of the actor policy of the actor-critic policy used to select the third action based on the target Q value comprises:
determining whether the target Q value is greater than the maximum of any Q value generated for the third observation by any of the actor-critic policies.

5. The method of claim 1, wherein performing an iteration of the prediction process comprises:
receiving an input observation for the prediction process, wherein:
for a first iteration of the prediction process, the input observation is either a second observation from a critic transition or a fourth observation from an actor transition, and
for any iteration of the prediction process that is after the first iteration, the input observation is a predicted observation generated at a preceding iteration of the prediction process;
selecting, using the mixture of actor-critic policies, an action to be performed by the agent in response to the input observation;
processing the input observation and the selected action using an observation prediction neural network to generate as output a predicted observation that characterizes a state that the environment would transition into if the agent performed the selected action when the environment was in a state characterized by the input observation; and
processing the input observation and the selected action using a reward prediction neural network to generate as output a predicted reward that is a prediction of a reward that would be received if the agent performed the selected action when the environment was in the state characterized by the input observation.

6. The method of claim 5, wherein determining a target Q value for an actor transition or a critic transition comprises:
performing a predetermined number of iterations of the prediction process; and
determining the imagined return estimate from (i) the predicted rewards for each of the predetermined number of iterations of the prediction process, and (ii) the maximum of any Q value generated for the predicted observation generated during a last iteration of the predetermined number of iterations by any of the actor-critic policies.

7. The method of claim 5, wherein performing the iteration of the prediction process further comprises:
processing the input observation and the selected action using a failure prediction neural network to generate as output a failure prediction of whether the task would be failed if the agent performed the selected action when the environment was in the state characterized by the input observation.

8. The method of claim 7, wherein determining a target Q value for an actor transition or a critic transition comprises:
performing iterations of prediction process until either (i) a predetermined number of iterations of the prediction process are performed or (ii) the failure prediction for a performed iteration indicates that the task would be failed; and
when the predetermined number of iterations of the prediction process are performed without the failure prediction for any of the iterations indicating that the task would be failed, determining the imagined return estimate from (i) the predicted rewards for each of the predetermined number of iterations of the prediction process and (ii) the maximum of any Q value generated for the predicted observation generated during a last iteration of the predetermined number of iterations by any of the actor-critic policies.

9. The method of claim 8, wherein determining a target Q value for an actor transition or a critic transition comprises:
when the failure prediction for a particular iteration indicates that the task would be failed, determining the imagined return estimate from the predicted rewards for each of the iterations of the prediction process that were performed and not from the maximum of any Q value generated for the predicted observation generated during the particular iteration by any of the actor-critic policies.

10. The method of claim 5, wherein the method further comprises training the observation prediction neural network, the reward prediction neural network, and the failure prediction neural network on the one or more actor transitions, the one or more critic transitions, or both.

11. The method of claim 10, wherein training the observation prediction neural network comprises training the observation prediction neural network to minimize a mean squared error loss function between predicted observations and corresponding observations from transitions.

12. The method of claim 10, wherein training the reward prediction neural network comprises training the reward prediction neural network to minimize a mean squared error loss function between predicted rewards and corresponding rewards from transitions.

13. The method of claim 10, wherein training the failure prediction neural network comprises training the failure prediction neural network to minimize a sigmoid cross-entropy loss between failure predictions and whether failure occurred in corresponding observations from transitions.

14. The method of claim 1, wherein the agent is an autonomous vehicle and wherein the task relates to autonomous navigation through the environment.

15. The method of claim 14, wherein the actions in the set of actions are different future trajectories for the autonomous vehicle.

16. The method of claim 14, wherein the actions in the set of actions are different driving intents.

17. A system comprising one or more computers and one or more storage devices storing instructions that are operable, when executed by the one or more computers, to cause the one or more computers to perform training of a mixture of a plurality of actor-critic policies that is used to control an agent interacting with an environment to perform a task, each actor-critic policy comprising:
an actor policy having a plurality of actor parameters and configured to receive an input comprising an observation characterizing a state of the environment and to generate a network output that identifies an action from a set of actions that can be performed by the agent, and
a critic policy having a plurality of critic parameters and configured to receive the observation and an action from the set of actions and to generate a Q value for the observation that is an estimate of a return that would be received if the agent performed the identified action in response to the observation, and the training comprising:
obtaining one or more critic transitions, each critic transition comprising:
a first training observation,
a reward received as a result of the agent performing a first action in response to the first training observation,
a second training observation characterizing a state of the environment that the environment transitioned into as a result of the agent performing the first action in response to the first training observation, and
data identifying the actor-critic policy from the mixture of actor-critic policies that was used to select the first action;
for each of the one or more critic transitions:
determining a target Q value for the critic transition from (i) the reward in the critic transition, and (ii) an imagined return estimate generated by performing one or more iterations of a prediction process to generate one or more predicted future transitions starting from the second training observation; and
determining an update to the critic parameters of the critic policy of the actor-critic policy used to select the first action using (i) the target Q value for the critic transition and (ii) a Q value for the first training observation generated using the actor-critic policy used to select the first action:
the operations of the respective method of any preceding claim.

18. The system of claim 17, wherein the training further comprises:
obtaining one or more actor transitions, each actor transition comprising:
a third training observation,
a reward received as a result of the agent performing a third action in response to the third training observation,
a fourth training observation characterizing a state of the environment that the environment transitioned into as a result of the agent performing the third action in response to the third training observation, and
data identifying the actor-critic policy from the mixture of actor-critic policies that was used to select the third action;
for each of the one or more actor transitions:
determining a target Q value for the actor transition from (i) the reward in the actor transition, and (ii) an imagined return estimate generated by performing one or more iterations of the prediction process to generate one or more predicted future transitions starting from the fourth training observation;
determining whether to update the actor parameters of the actor policy of the actor-critic policy used to select the third action based on the target Q value; and
in response to determining to update the actor parameters of the actor policy of the actor-critic policy used to select the third action, determining an update to the actor parameters of the actor policy of the actor-critic policy used to select the third action using an action identified for the third training observation generated using the actor-critic policy used to select the third action.

19. A computer storage medium encoded with instructions that, when executed by one or more computers, cause the one or more computers to perform training of a mixture of a plurality of actor-critic policies that is used to control an agent interacting with an environment to perform a task, each actor-critic policy comprising:
an actor policy having a plurality of actor parameters and configured to receive an input comprising an observation characterizing a state of the environment and to generate a network output that identifies an action from a set of actions that can be performed by the agent, and
a critic policy having a plurality of critic parameters and configured to receive the observation and an action from the set of actions and to generate a Q value for the observation that is an estimate of a return that would be received if the agent performed the identified action in response to the observation, and the training comprising:
obtaining one or more critic transitions, each critic transition comprising:
a first training observation,
a reward received as a result of the agent performing a first action in response to the first training observation,
a second training observation characterizing a state of the environment that the environment transitioned into as a result of the agent performing the first action in response to the first training observation, and
data identifying the actor-critic policy from the mixture of actor-critic policies that was used to select the first action;
for each of the one or more critic transitions:
determining a target Q value for the critic transition from (i) the reward in the critic transition, and (ii) an imagined return estimate generated by performing one or more iterations of a prediction process to generate one or more predicted future transitions starting from the second training observation; and
determining an update to the critic parameters of the critic policy of the actor-critic policy used to select the first action using (i) the target Q value for the critic transition and (ii) a Q value for the first training observation generated using the actor-critic policy used to select the first action:
the operations of the respective method of any preceding claim.

20. The computer storage medium of claim 19, wherein the training further comprises:
obtaining one or more actor transitions, each actor transition comprising:
a third training observation,
a reward received as a result of the agent performing a third action in response to the third training observation,
a fourth training observation characterizing a state of the environment that the environment transitioned into as a result of the agent performing the third action in response to the third training observation, and
data identifying the actor-critic policy from the mixture of actor-critic policies that was used to select the third action;
for each of the one or more actor transitions:
determining a target Q value for the actor transition from (i) the reward in the actor transition, and (ii) an imagined return estimate generated by performing one or more iterations of the prediction process to generate one or more predicted future transitions starting from the fourth training observation;
determining whether to update the actor parameters of the actor policy of the actor-critic policy used to select the third action based on the target Q value; and
in response to determining to update the actor parameters of the actor policy of the actor-critic policy used to select the third action, determining an update to the actor parameters of the actor policy of the actor-critic policy used to select the third action using an action identified for the third training observation generated using the actor-critic policy used to select the third action.
